(19) United States
(12) Patent Application Publication
(10) Pub. No.: US 2011/0014335 A1
(43) Pub. Date: Jan. 20, 2011

(54) Absorbent Frozen Confection Holder

(76) Inventor: Rachel Marie Dyess, Yellville, AR (US)

Correspondence Address: Rachel Dyess, 13823 Hwy 14 S, Yellville, AR, 72687, US

(21) Appl. No.: 12/838,383

(22) Filed: Jul. 16, 2010

Related U.S. Application Data
(60) Provisional application No. 61/226,322, filed on Jul. 17, 2009.

(51) Int. Cl. B65D 75/00; A23G 9/22

(52) U.S. Cl. 426/420; 229/87.08

(57) ABSTRACT

Apparatus, and an associated method, for absorbing excess moisture and melted confection that simultaneously protects bare hands from extreme temperatures of a frozen confection. An apparatus is provided for absorbing condensation and melted confection while protecting bare hands by wrapping one or more layers of absorbent material around a frozen confection and affixing the ends by means of a fastener.

### CROSS REFERENCE TO RELATED APPLICATIONS

Provisional Application No: 61/226,322

### STATEMENT REGARDING FEDERALLY SPONSORED RESEARCH OR DEVELOPMENT

Invention is not federally sponsored for research or development.

### REFERENCE TO SEQUENCE LISTING, A TABLE, OR A COMPUTER PROGRAM LISTING COMPACT DISC APPENDIX

Not Applicable

### BACKGROUND OF THE INVENTION

Frozen cylindrical confections (i.e. freezer pops, electrolyte pops, yogurt tubes, etc.) are very popular among people of all ages.

These confections are usually stored in the freezer, removed and immediately gripped in one's hand. The temperature change caused by one's hand and the temperature of the air causes these confections to melt quickly.

As the confection melts, condensation gathers on the outside of the confection causing the wrapper to become uncomfortable and slippery. This increases the chances that the confection will be dropped.

Young children are prone to making messes. When eating frozen confections, their lack of motor skills and coordination causes them to smear the confection on their faces, hands and clothing.

The cold temperature of the frozen confection also makes hands uncomfortable.

Paper towels are commonly used to try to remedy messes and discomfort. Unfortunately, these cannot be fastened around the confection and frequently have to be readjusted. They also are not reusable.

A reusable apparatus that is absorbent would prevent discomfort caused by condensation, melted confection messes and extreme temperatures while saving natural resources.

### BRIEF SUMMARY OF THE INVENTION

The present invention provides apparatus, and an associated method, for holding a frozen confection while absorbing condensation and melted confection and protecting hands from extreme temperature and moisture.

In preferred embodiment, the apparatus is formed of a one or more layers of absorbent material, so that the material may be wrapped around the confection and fastened around the object. Preferred materials are terry cloth and cotton. Other materials include but are not limited to: sponges and various types of fabrics.

A fastener such as hook and loop secures the absorbent material around the confection. Other fasteners include but are not limited to: magnetic strips, snaps, zippers, etc.

Because the absorbent material is reusable, it can be easily machine washed thus saving natural resources (i.e. trees used for paper towel production).

### BRIEF DESCRIPTION OF DRAWINGS

FIG. 1A illustrates the preferred embodiment 10 of the present invention secured around the wrapper 12 of the frozen confection 14.

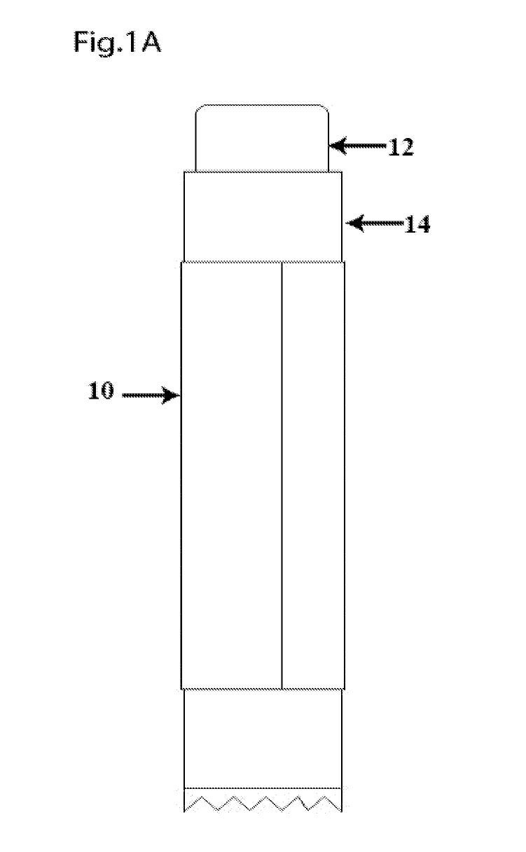

FIG. 1B illustrates the preferred embodiment of the present invention 10 laid flat with loop fastener 16 face up and the absorbent material (terry cloth in this case) 18 face up.

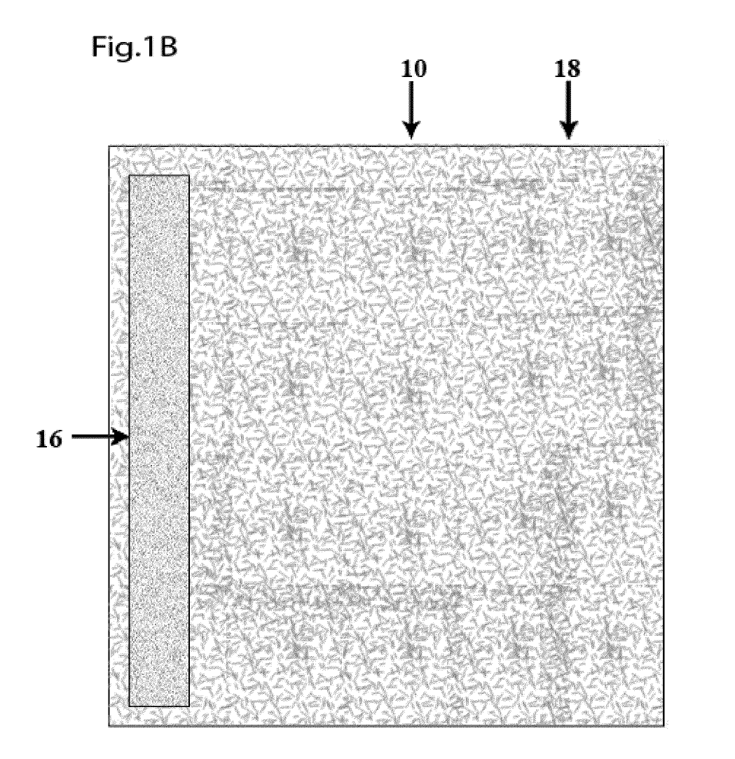

FIG. 1C illustrates the preferred embodiment of the present invention 10 laid flat with loop fastener 16 face up and the absorbent material (terry cloth in this case) 18 face up and one corner pulled back revealing the opposite side of the apparatus 20 and hook fastener 22 attached to opposite side.

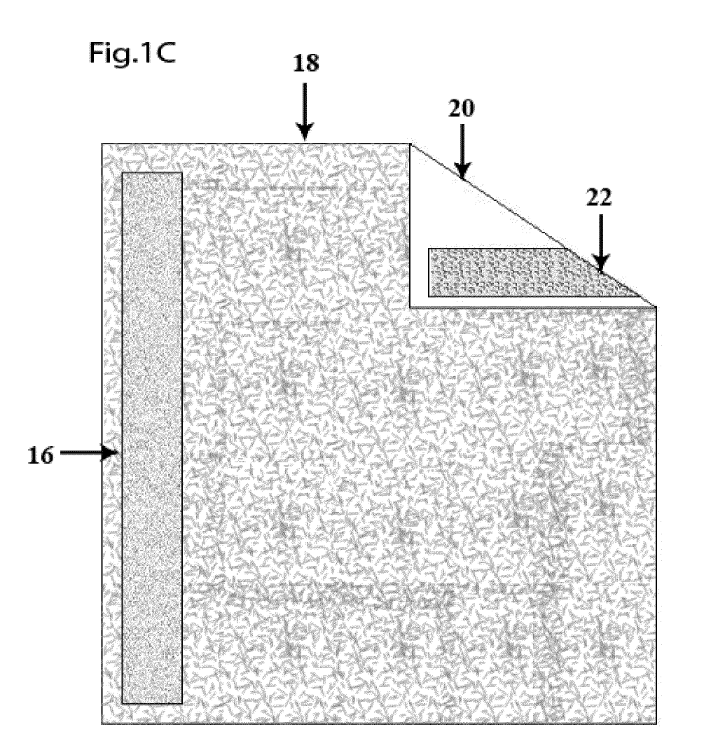

FIG. 1D illustrates the preferred embodiment of the present invention laid flat with a third of the apparatus folded over illustrating both front 18 and back 20 of apparatus.

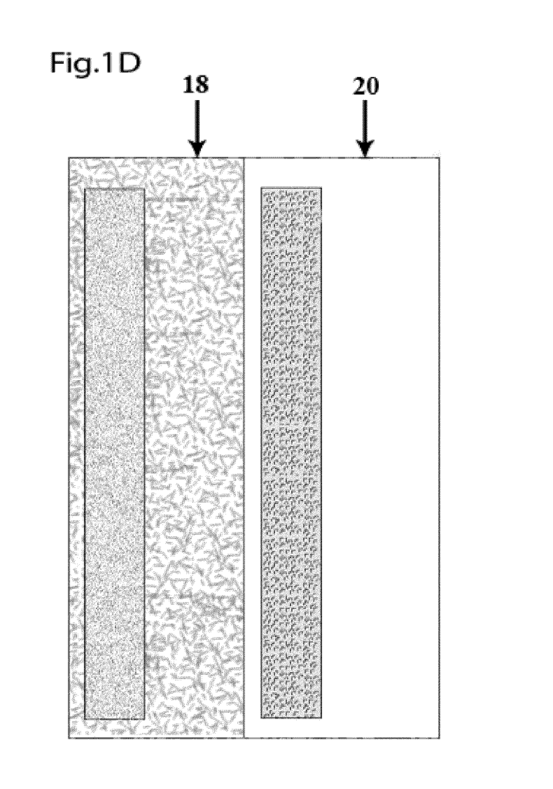

### DETAILED DESCRIPTION OF INVENTION

The present invention provides apparatus, and an associated method, for holding a frozen confection while absorbing condensation and melted confection and protecting hands from extreme temperature and moisture.

Preferred embodiment of apparatus is comprised of one or more layers of absorbent material such as terry cloth or cotton, but could also include but is not limited to other absorbent materials such as sponges or various absorbent fabrics. If more than one layer is used, they can be attached together via various methods including but not limited to machine stitching, adhesives, etc.

Apparatus is secured around frozen confection through various means including but not limited to hook and loop fasteners, magnets, snaps, etc. which can be attached to the invention via various methods.

The preferred embodiment of the apparatus easily adjusts to fit narrow and wide cylindrical frozen confections. Prior inventions are cylindrical with openings at the top and bottom to slide the frozen confection through. The size of the frozen confection is limited to the size of the opening of the cylinder. The consumer would have to purchase several sizes in order to accommodate the different sizes.

Apparatus can be easily opened and snugly secured around the frozen confection. In the case of some prior inventions, the frozen confection has to be slightly heated in order to partially melt the confection so that the apparatus could be placed around it. This causes undesirable effects due to the confection being partially melted and causing messes and defeats the purpose of a “frozen” confection.

Because prior inventions do not easily fit and are not easily secured around the confection, the apparatus must be placed at the very bottom of the confection. This makes it difficult for small children to hold on to the confection without dropping it especially in the case of jumbo size freezer pops. The current invention solves this problem by placing the apparatus anywhere on the confection thus making it easier for young children to handle.

Because the apparatus is comprised of one or more layers of absorbent material, the apparatus not only absorbs excess moisture but simultaneously protects hands from extreme cold. Prior inventions provide for temperature protection, but are not absorbent and therefore are not able to prevent messy hands and clothes which is one of the biggest concerns for parents and can cause a lot of discomfort for children.

Currently, multitudes of parents wrap paper towels around frozen confections such as freezer pops, electrolyte pops, yogurt tubes, etc. in order to keep messes contained and fingers comfortable. Because they cannot be secured around the confection and are thin, they do not do an adequate job containing messes and guarding against extreme temperatures.

Taking care of our environment and protecting our resources are big concerns. The apparatus eliminates the need for disposable paper products to be wrapped around frozen confections. The apparatus can be machine or hand washed over and over again.

Because of the nature of the materials used to construct the preferred embodiment of the invention, the apparatus poses no choking hazards to small children. Prior inventions comprised of foam type products are very tempting for small children to try to eat.

Because of the absorbent nature of the invention, the apparatus can be removed and used to wipe face and hands when the confection is gone.

The preferred embodiment of the invention is constructed of but not limited to readily available materials such as terry cloth and cotton, which lends itself to inexpensive retail prices for the consumer. Other inventions made of materials such as neoprene are a lot more costly.

1. Absorbent apparatus for holding frozen confections and absorbing excess moisture and liquids, said apparatus comprised of: one or more layers of absorbent material that can be secured around the frozen confection by means of an affixer positioned at said absorbent material to affix the front side against the back side such that, when affixed together creates a cylindrical absorbent apparatus that permits the positioning of a frozen confection between said sides.

2. The apparatus of claim 1 wherein the absorbent material comprises of terry cloth.

3. The apparatus of claim 1 wherein the absorbent material comprises of cotton and cotton blends.

4. The apparatus of claim 1 wherein the affixer comprises a hook-and-loop type fastener.

5. The apparatus of claim 1 wherein the affixer comprises a snap.

6. The apparatus of claim 1 wherein the affixer comprises a hook-and-eye type fastener.

7. A method for absorbing excess moisture and liquids from a frozen confection comprising: positioning a frozen confection on one or more layers of absorbent material; folding said layers of absorbent material around the confection such that a first side part of said absorbent material fits against a second side part thereof; and affixing the first side part against the second side part.

8. The method of claim 7 wherein the absorbent material comprises of terry cloth.

9. The method of claim 7 wherein the absorbent material comprises of cotton and cotton blends.

10. The method of claim 7 wherein the affixer comprises a hook-and-loop type fastener.

11. The method of claim 7 wherein the affixer comprises a snap.

12. The method of claim 7 wherein the affixer comprises a hook-and-eye type fastener.
